(19) United States
(12) Patent Application Publication
(10) Pub. No.: US 2015/0158976 A1
(43) Pub. Date: Jun. 11, 2015

(54) ALKANOLYSIS PROCESS AND METHOD FOR SEPARATING CATALYST FROM PRODUCT MIXTURE

(71) Applicant: INVISTA NORTH AMERICA S.A.R.L., Wilmington, DE (US)

(72) Inventors: Suri N. Dorai, Weston Lakes, TX (US); Qun Sun, Wilmington, DE (US)

(73) Assignee: INVISTA NORTH AMERICA S.A.R.L., Wilmington, DE (US)

(21) Appl. No.: 14/407,296

(22) PCT Filed: Jun. 12, 2013
(86) PCT No.: PCT/US2013/045412

§ 371 Date: Dec. 11, 2014

Related U.S. Application Data
(60) Provisional application No. 61/663,015, filed on Jun. 22, 2012.

(51) Int. Cl. C08G 65/48; B01J 19/24

(52) U.S. Cl. CPC C08G 65/48; B01J 19/24; B01J 2219/24

(57) ABSTRACT

The present invention provides an improved process and apparatus for alkanolysis of polytetramethylene ether diacetate to polytetraalkylene ether glycol in the presence of a C1 to C4 alkanol and an alkali or alkaline earth metal catalyst wherein the catalyst component of the product mixture comprising polytetraalkylene ether glycol, alkanol and catalyst, essentially free of the alkanol acetate by-product, e.g., methyl acetate is removed by contacting the mixture in the absence of added water with certain ion exchange resin at specified contact conditions. The invention further provides a highly efficient method for removing the catalyst component of a mixture comprising polytetraalkylene ether glycol, alkanol and alkali or alkaline earth metal catalyst by contacting the mixture in the absence of added water with certain ion exchange resin at specified contact conditions,

### CROSS-REFERENCE TO RELATED APPLICATION

This application claims benefit of priority from U.S. Provisional Application No. 61/663,015 filed Jun. 22, 2012. This application hereby incorporates by reference this provisional application in its entirety.

### FIELD OF THE INVENTION

The present invention relates to an improved process and apparatus for alkanolysis of polyether polyol esters to polyether polyols. More particularly, the invention relates to the alkanolysis of polytetramethylene ether diacetate to polytetraalkylene ether glycol in the presence of a C₁ to C₄ alkanol and an alkali or alkaline earth metal catalyst wherein the catalyst component of the product mixture comprising polytetraalkylene ether glycol, alkanol and catalyst, essentially free of the alkanol acetate by-product, e.g., methyl acetate is removed by contacting the mixture in the absence of added water with certain ion exchange resin at specified contact conditions. Even more particularly, the invention relates to a highly efficient method for removing the catalyst component of a mixture comprising polytetraalkylene ether glycol, alkanol and alkali or alkaline earth metal catalyst by contacting the mixture in the absence of added water with certain ion exchange resin at specified contact conditions.

### BACKGROUND OF THE INVENTION

Polytetramethylene ether glycol (PTMEG) is well known for use as soft segments in polyurethanes and other elastomers. This homopolymer is a commodity in the chemical industry which is widely used to form segmented copolymers with poly-functional urethanes and polyesters. PTMEG imparts superior dynamic properties to polyurethane elastomers and fibers.

It is known that in the preparation of polyether polyols, generally and specifically the polymerization of tetrahydrofuran (THF) and/or THF with comonomers in which acetic acid and acetic anhydride are used, the intermediate products will contain acetate or other end groups which must be subsequently converted to the hydroxyl functionality prior to ultimate use. For example, U.S. Pat. No. 4,163,115 discloses the polymerization of THF and/or THF with comonomers to polytetramethylene ether diester using a fluorinated resin catalyst containing sulfonic acid groups, in which the molecular weight is regulated by addition of an acylium ion precursor to the reaction medium. The patent discloses the use of acetic anhydride and acetic acid in combination with the solid acid catalyst. The polymeric product is isolated by stripping off the unreacted THF and acetic acid/acetic anhydride for recycle. The isolated product is the diacetate of polymerized tetrahydrofuran (PTMEA) which must be converted to the corresponding dihydroxy product, polytetramethylene ether glycol (PTMEG), to find application as a raw material in most urethane end use applications. Consequently, the ester end-capped polytetramethylene ether is reacted with a basic catalyst and an alkanol such as methanol to provide the final product polytetramethylene ether glycol and methyl acetate as a by-product.

U.S. Pat. Nos. 4,230,892 and 4,584,414 disclose processes for the conversion of PTMEA to PTMEG comprising mixing a polytetramethylene ether diester with an alkanol of 1 to 4 carbons, and a catalyst which is an oxide, hydroxide, or alkoxide of an alkaline earth metal or an alkali metal hydroxide or alkoxide; bringing the mixture to its boiling point and holding it there while the vapors of the alkanol/alkyl ester azeotrope which form are continuously removed from the reaction zone, until conversion is essentially complete; and then removing the catalyst.

U.S. Pat. No. 5,852,218 discloses reactive distillation wherein a diester of polyether polyol, e.g. PTMEA, is fed to the top portion of the distillation column along with an effective amount of at least one alkali metal or alkaline earth metal oxide, hydroxide or alkoxide catalyst (e.g., sodium methoxide) and with a C₁ to C₄ alkanol (e.g., methanol) while simultaneously adding to the bottom of the reactive distillation column hot alkanol vapor to sweep any alkanol ester formed by alkanolysis of the diester of polyether polyol upwardly.

U.S. Pat. No. 4,460,796 discloses a process for separating basic transesterification catalyst from mixture with PTMEG comprising adding a prescribed amount of orthophosphoric acid to the mixture to neutralize the catalyst, and thereafter separating the salts which are firmed.

U.S. Pat. No. 5,254,227 discloses a process for removing strongly ionic metallic impurity from a polyol mixture requiring a certain critical amount of water comprising passing the mixture through an ion exchange compartment containing an ion exchange medium and membrane-separated anode and cathode compartments, and sending electric current across the ion exchange compartment. U.S. Pat. No. 6,037,381 discloses a process for removal of sodium cations from a polytetrahydrofuran solution in the presence of a certain critical amount of water following transesterification by passing the solution through an ion exchanger.

U.S. Pat. No. 4,985,551 discloses a process for ion exchange of polyols for alkali hydroxide or alkoxide catalyst removal requiring sequential steps of mixing with a certain critical amount of water, blending with a certain critical amount of lower aliphatic alcohol, and passing the product through microporous cation exchange resin. U.S. Pat. No. 6,037,381 relates to a method for removing sodium methoxide catalyst that includes adding a critical amount of water. U.S. Pat. No. 6,716,937 discloses a process for preparation of polytetrahydrofuran or tetrahydrofuran copolymers in the presence of a certain critical amount of water comprising a step of separating the suspended or dissolved catalyst or downstream products of the catalyst from the resulting stream by adsorption on solid adsorbents or ion exchange resins. U.S. Pat. No. 6,878,802 discloses a process involving transesterification with alcohol in the presence of alkaline earth metal-containing catalyst followed by passing the product solution in the presence of a certain critical amount of water through an ion exchanger to remove alkaline earth metal ions.

It would be desirable to provide alkanolysis of polytetramethylene ether diacetate to polytetraalkylene ether glycol in the presence of a C₁ to C₄ alkanol and an alkali or alkaline earth metal catalyst wherein the catalyst component of the product mixture comprising polytetraalkylene ether glycol, alkanol and catalyst, essentially free of the alkanol acetate by-product, e.g., methyl acetate is removed by contacting the mixture in the absence of added water with certain ion exchange resin at specified contact conditions required in the present invention. What appears lacking in the state of the art is a highly efficient method for removing the catalyst component of a mixture comprising polytetraalkylene ether glycol, alkanol and alkali or alkaline earth metal catalyst by contacting the mixture in the absence of added water with certain ion exchange resin at specified contact conditions required in the present invention. In a commercial methanolysis process, the presence of an excessive amount of water, for example >3000 ppmw, for example >2000 ppmw, in the alkanol stream which will be recycled is a serious problem. This problem requires additional water removal steps which are avoided by the present invention.

### SUMMARY OF THE INVENTION

The present invention provides an improved process for alkanolysis of polyether polyol esters to polyether polyols. More particularly, the invention relates to the alkanolysis, e.g. methanolysis, of polytetramethylene ether diacetate to polytetraalkylene ether glycol, e.g. polytetramethylene ether glycol, in the presence of a C₁ to C₄ alkanol, e.g. methanol, and an alkali or alkaline earth metal catalyst, e.g. sodium methylate, wherein the catalyst component of the resulting product mixture comprising polytetraalkylene ether glycol, alkanol and catalyst, essentially free of the alkanol acetate by-product, e.g., methyl acetate is removed by contacting the mixture in the absence of added water with certain ion exchange resin at contact conditions including a temperature of from 40 to 80° C., for example 40 to 70° C., pressure from ambient to 3 bars, and/or flow rate from 0.5 to 5.0 liters feed/liters of resin-hour. The present invention, therefore, provides an improved process for achieving virtually complete recovery of polytetraalkylene ether glycol, e.g. PTMEG, product free of catalyst or catalyst by-product.

An embodiment of the present invention comprises a process for converting the diester of a polyether polyol to a corresponding dihydroxy polyether polyol comprising steps of: (1) contacting the diester of a polyether polyol and a C₁ to C₄ alkanol with alkali or alkaline earth metal catalyst in a reaction zone to convert at least a portion of the diester, for example >99 wt. %, for example >99.99 wt. %, to the dihydroxy polyether polyol, (2) recovering reaction zone effluent from step (1) comprising dihydroxy polyether polyol, alkanol and catalyst, essentially free of the alkanol acetate by-product, e.g., methyl acetate from the reaction zone, (3) contacting the recovered reaction zone effluent of step (2), in the absence of added water, with a strongly acidic ion exchange resin with active sites less than or equal to 5.3 eq/kg, surface area of from about 30 to about 70 m2/gram in the form of particles of any suitable size consistent with ease of handling and pressure drop across the reactor bed, for example, particle sizes greater than 0.5 mm, said contacting being performed at conditions including temperature of from liters feed/liters of resin-hour 40 to 80° C., for example 40 to 70° C., pressure from ambient to 3 bars, and/or flow rate from 0.5 to 5.0 liters feed/liters of resin-hour and (4) recovering effluent from contacting step (3) comprising less than 1.0 ppm alkali or alkaline earth metal ions.

An embodiment of the present invention comprises a method for removing alkali or alkaline earth metal catalyst from a mixture comprising polytetraalkylene ether glycol, alkanol and alkali or alkaline earth metal catalyst, which comprises steps of: (1) contacting the mixture with ion exchange resin with active sites less than or equal to 5.3 eq/kg, surface area of from about 30 to about 70 m2/gram in the form of particles of any suitable size consistent with ease of handling and pressure drop across the reactor bed, for example, particle sizes greater than 0.5 mm, at contact conditions including a temperature of from 40 to 80° C., for example 40 to 70° C., pressure from ambient to 3 bars, and/or flow rate from 0.5 to 5.0 liters feed/liters of resin-hour, and (2) recovering effluent mixture from step (1) comprising less than 1.0 ppm alkali or alkaline earth metal ions. In a preferable embodiment, the contact conditions include a temperature of from liters feed/liters of resin-hour 40 to 80° C., for example 40 to 70° C., pressure from ambient to 3 bars, and/or flow rate from 0.5 to 5.0 liters feed/liters of resin-hour.

It is an object of the present invention to provide an improved process for the alkanolysis of polyether polyol esters to produce polyether polyol. It is a further object to provide an efficient method for removing alkali or alkaline earth metal catalyst from a mixture comprising polytetraalkylene ether glycol, alkanol and alkali or alkaline earth metal catalyst. Fulfillment of these objects and additional objects will become apparent upon reading the specification and claims herein presented.

Another embodiment of the present invention comprises an apparatus for converting the diester of a polyether polyol to a corresponding dihydroxy polyether polyol, comprising: (1) a reactor for contacting the diester of a polyether polyol and a C₁ to C₄ alkanol with alkali or alkaline earth metal catalyst to convert at least a portion of the diester, for example >99 wt. %, for example >99.99 wt. %, to the dihydroxy polyether polyol to produce a reactor effluent; and (2) an ion exchange resin column packed with ion exchange resin having active sites less than or equal to 5.3 eq/kg, surface area of from about 30 to about 70 m2/gram in the form of particles of size consistent with ease of handling and acceptable pressure drop across the ion exchange resin column, being operatively connected to the reactor, for contacting the reactor effluent, in the absence of added water, with the ion exchange resin, said contacting being performed at conditions including temperature of from liters feed/liters of resin-hour 40 to 80° C., for example 40 to 70° C., pressure from ambient to 3 bars, and/or flow rate from 0.5 to 5.0 liters feed/liters of resin-hour.

### BRIEF DESCRIPTION OF THE DRAWING

FIG. 1 shows a diagrammatic flow of an embodiment of the present apparatus for carrying out the process of the invention.

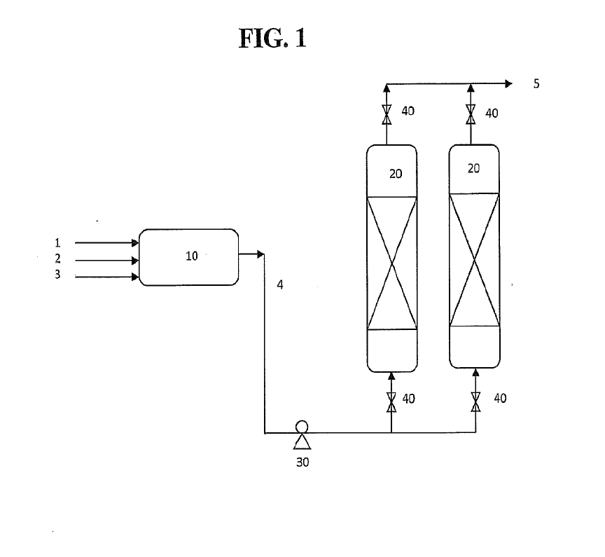

### DETAILED DESCRIPTION OF THE INVENTION

As a result of intense research in view of the above, we have discovered an improved process whereby we can manufacture a dihydroxy polyether polyol, e.g. polytetramethylene ether glycol (PTMEG), from the diester of polyether polyol, e.g. PTMEA, and recover dihydroxy polyether polyol essentially free of catalyst or catalyst by-product.

The term “polymerization”, as used herein, unless otherwise indicated, includes the term “copolymerization” within its meaning.

The term “PTMEG”, as used herein, unless otherwise indicated, means polytetramethylene ether glycol. PTMEG is also known as polyoxybutylene glycol.

The term “THF”, as used herein, unless otherwise indicated, means tetrahydrofuran and includes within its meaning alkyl substituted tetrahydrofuran capable of copolymerizing with THF, for example 2-methyltetrahydrofuran, 3-methyltetrahydrofuran, and 3-ethyltetrahydrofuran.

The term “alkylene oxide”, as used herein, unless otherwise indicated, means a compound containing two, three or four carbon atoms in its alkylene oxide ring. The alkylene oxide can be unsubstituted or substituted with, for example, linear or branched alkyl of 1 to 6 carbon atoms, or aryl which is unsubstituted or substituted by alkyl and/or alkoxy of 1 or 2 carbon atoms, or halogen atoms such as chlorine or fluorine. Examples of such compounds include ethylene oxide (EO); 1,2-propylene oxide; 1,3-propylene oxide; 1,2-butylene oxide; 1,3-butylene oxide; 2,3-butylene oxide; styrene oxide; 2,2-bis-chloromethyl-1,3-propylene oxide; epichlorohydrin; perfluoroalkyl oxiranes, for example (1H,1H-perfluoropentyl) oxirane; and combinations thereof.

The term “catalyst”, as used herein, unless otherwise indicated, means oxide, hydroxide, or alkoxide of an alkali or alkaline earth metal, such as, for example, sodium or a hydroxide or alkoxide of an alkali metal, such as, for example, sodium methylate, or by-product thereof, such as, for example, sodium methylate or sodium hydroxide.

The THF referred to herein can be any of those commercially available. Typically, the THF has a water content of less than about 0.03% by weight and a peroxide content of less than about 0.005% by weight. If the THF contains unsaturated compounds, their concentration should be such that they do not have a detrimental effect on the polymerization process or the polymerization product thereof. Optionally, the THF can contain an oxidation inhibitor such as butylated hydroxytoluene (BHT) to prevent formation of undesirable byproducts and color. If desired, one or more alkyl substituted THF's capable of copolymerizing with THF can be used as a co-reactant, in an amount from about 0.1 to about 70% by weight of the THF. Examples of such alkyl substituted THF's include 2-methyltetrahydrofuran, 3-methyltetrahydrofuran, and 3-ethyltetrahydrofuran.

The alkylene oxide referred to herein, as above indicated, may be a compound containing two, three or four carbon atoms in its alkylene oxide ring. The alkylene oxide can be unsubstituted or substituted with, for example, alkyl groups, aryl groups, or halogen atoms. It may be selected from, for example, the group consisting of ethylene oxide (EO); 1,2-propylene oxide; 1,3-propylene oxide; 1,2-butylene oxide; 2,3-butylene oxide; 1,3-butylene oxide; 2,2-bischloromethyl oxetane; epichlorohydrin and combinations thereof. Preferably, the alkylene oxide has a water content of less than about 0.03% by weight, a total aldehyde content of less than about 0.01% by weight, and an acidity (as acetic acid) of less than about 0.002% by weight. The alkylene oxide should be low in color and non-volatile residue.

If, for example, the alkylene oxide reactant is EO, it can be any of those commercially available. Preferably, the EO has a water content of less than about 0.03% by weight, a total aldehyde content of less than about 0.01% by weight, and an acidity (as acetic acid) of less than about 0.002% by weight. The EO should be low in color and non-volatile residue.

THF can be polymerized using solid acid resin catalyst and acetic acid/acetic anhydride as molecular weight moderators as described in U.S. Pat. No. 4,163,115, incorporated herein by reference. Typically the THF conversion to polymer ranges from about 20 to 40% at temperature of about 40° C. to 60° C. The polymeric product is preferably isolated by stripping off the unreacted THF and acetic acid/acetic anhydride for recycle. The product so isolated is the polymerized diacetate of tetrahydrofuran (PTMEA), which must be converted to the dihydroxy product polytetramethylene ether glycol (PTMEG) to find application as a raw material in most urethane end use applications.

The polyether polyol diester composition used herein is generally any polyether such as polyether typically produced via an acid catalyzed ring opening polymerization reaction of a cyclic ether or mixture in the presence of a carboxylic acid and carboxylic acid anhydride wherein tetrahydrofuran is the major and/or dominant reactant; i.e., substantial THF being incorporated into the PTMEA product. More specifically, the polyether diester is derived from the polymerization of tetrahydrofuran (THF) with or without an alkyl substituted tetrahydrofuran comonomer, preferably for example 3-methyl tetrahydrofuran (3-MeTHF), as well as the copolymerization of THF (again with or without 3-MeTHF) and with an alkylene oxide such as ethylene oxide or propylene oxide or equivalent comonomer. As such, the following description and examples will predominantly refer to THF with the understanding that the other comonomers may optionally be present.

Typically the products of the initial polymerization process are in the form of acetates (or similar terminal ester groups) which are converted to the hydroxyl group terminated glycols by reacting them with methanol in the presence of transesterification/alkanolysis catalysts. This reaction requires a catalyst to attain reasonable rates. Common methanolysis catalysts useful for this purpose include sodium methoxide (NaOMe or NaOCH₃), sodium hydroxide (NaOH), and calcium oxide. In principle the catalyst useful for such a reaction is a highly alkaline alkanolysis catalyst generally categorized as an alkali metal or alkaline earth metal oxide, hydroxide or alkoxide catalyst and mixtures thereof as taught in U.S. Pat. Nos. 4,230,892 and 4,584,414 (here incorporated by reference for such purpose). Commonly used are alkanolysis catalysts that inherently have some water scavenging capability without loss of catalyst activity (e.g., NaOH/NaOCH₃/Na₂O system wherein trace water is converted to the catalytically active NaOH). The reaction rate using NaOH/NaOCH₃ is rapid even at room temperature and therefore methanolysis is ordinarily carried out at atmospheric pressure. The by-product in this methanolysis is methyl acetate which forms a lower boiling azeotrope with methanol. The alkanolysis reaction is reversible and therefore continuous removal of volatile methyl acetate/methanol azeotrope is essential to obtain a commercially reasonable conversion rate. In the process of U.S. Pat. No. 5,852,218, this is done in a reactive distillation column wherein methanol vapor is fed into the column bottom to strip the polymer of methyl acetate. By stripping methyl acetate in this manner, high conversion of PTMEA to PTMEG, for example greater than 99%, is achieved in the column. In contrast to the reactive distillation process at least five sequential continuously stirred reactor stages may be required to achieve complete conversion.

In transesterification processes commercially used for conversion of PTMEA to PTMEG, the highly alkaline catalyst generally categorized as an alkali metal or alkaline earth metal oxide, hydroxide or alkoxide, presents problems such as remaining with product PTMEG and unreacted alkanol to form a mixture comprising PTMEG, sodium methylate and sodium hydroxide. The catalyst must be removed from that mixture.

The catalyst is present in the alkanolysis step of the present invention in a catalytically effective amount, which in the usual case means a concentration of from about 0.01% to about 0.5% by weight, for example 0.02 to 0.2% by weight of the PTMEA.

The alkanolysis step of the present invention is generally carried out at from about 60° C. to about 90° C. The pressure is ordinarily atmospheric pressure, but reduced or elevated pressure may be used to aid in controlling the temperature of the reaction mixture during the reaction. For example, the pressure employed may be from about 1 to about 50 psig.

Amberlyst-15 sulfonic acid resin can be used in the process to remove the catalyst from the reactor effluent in the alkanolysis step, wherein Amberlyst-15 sulfonic acid resin, which is a strong acid ion exchange resin, was obtained from Dow Chemical Company. However, any suitable acid resin with comparable properties is acceptable. For example, a suitable ion exchange resin can have active sites less than or equal to 5.3 eq/kg, surface area of from about 30 to about 70 m2/gram, and be in the form of particles of any suitable size consistent with ease of handling and pressure drop across the reactor bed, for example, particle sizes greater than 0.5 mm. Prior to use, the ion exchange resin may optionally be pretreated to remove any color and free acid, the Amberlyst-15 resin was rinsed with an acetone/deionized water mixture 4 times, followed by further rinses with deionized water 6 times until the rinse water was nearly neutral, for example, the pH was in the range of 5 to 7. The Amberlyst-15 resin was then dried in a full vacuum oven at 95° C. overnight to remove residue moisture before packing the resin into a fixed bed glass column for the experiments.

The apparatus for converting the diester of a polyether polyol to a corresponding dihydroxy polyether polyol may comprises: (1) a reactor 10 for contacting the diester of a polyether polyol 1 and a C₁ to C₄ alkanol 2 with alkali or alkaline earth metal catalyst 3 to convert at least a portion of the diester, for example >99 wt. %, for example >99.99 wt. %, to the dihydroxy polyether polyol to produce a reactor effluent 4; and (2) an ion exchange resin column 20 packed with ion exchange resin having active sites less than or equal to 5.3 eq/kg, surface area of from about 30 to about 70 m2/gram in the form of particles of size consistent with ease of handling and acceptable pressure drop across the ion exchange resin column, being operatively connected to the reactor 10, for contacting the reactor effluent, in the absence of added water, with the ion exchange resin, said contacting being performed at conditions including temperature of from 40 to 80° C., and pressure from 760 to 900 mmHg. In a preferable embodiment, the contact conditions include a temperature of from 40 to 80° C., and pressure from 760 to 900 mmHg, and flow rate from ½ to 5 liters feed/liters of resin-hour

The apparatus of the invention may further comprises a pump 30 between the reactor 10 and the exchange resin column 20 for feeding the reactor effluent 4 into the exchange resin column 20 such that the reactor effluent 4 in the exchange resin column 20 has a flow rate from ½ to 5 liters feed/liters of resin-hour.

Preferably, the apparatus of the invention may further comprises a pump 30 between the reactor 10 and the exchange resin column 20 for feeding the reactor effluent 4 into the exchange resin column 20 from the bottom of the exchange resin column 20 such that the reactor effluent 4 in the exchange resin column 20 has an upward flow rate from ½ to 5 liters feed/liters of resin-hour.

The effluent 5 comprising less than 1.0 ppm alkali or alkaline earth metal ions is recovered from the exchange resin column 20. The apparatus of the invention may comprises 2 exchange resin columns, wherein one performs the contacting, while the other is regenerated or stands by. The valves 40 is opened or closed to direct the effluent 4 into one or both of the exchange resin column.

The number average molecular weight of the PTMEG product of this invention, determined by end group analysis using spectroscopic methods well known in the art, can be as high as about 30,000 dalton, for example, 10,000 dalton, but will usually range from 500 to about 5000 dalton, and more commonly will range from about 500 to 3000 dalton. The product mixture of the alkanolysis process will commonly comprise from about 50 to about 80 wt. % polytetraalkylene ether glycol, e.g. PTMEG, from about 20 to about 50 wt. % alkanol, e.g. methanol, and from 100 to 2000 ppm catalyst.

The present process can be carried out in any suitable reactor, such as a continuous stirred tank reactor (CSTR), a batch reactor, a tubular concurrent reactor or any combination of one or more reactor configurations known to those skilled in this art. If using reactive distillation, a single distillation column can be employed in a continuous manner. The reactive distillation can be performed by any of the distillation process and equipment as generally known and practiced in the art. For example but not by way of limitation, a deep seal sieve tray distillation column can be used. A conventional tray distillation column is similarly suitable.

The following Examples demonstrate the present invention and its capability for use. The invention is capable of other and different embodiments, and its several details are capable of modifications in various apparent respects, without departing from the spirit and scope of the present invention. Accordingly, the Examples are to be regarded as illustrative in nature and non-limiting.

### EXAMPLES

In the examples, the PTMEG was obtained from INVISTA. Anhydrous methanol and anhydrous sodium methoxide (NaOCH₃)/methanol solutions were obtained from Sigma-Aldrich Chemicals. Amberlyst-15 sulfonic acid resin, a strong acid ion exchange resin was obtained from Dow Chemical Company. In this example Amberlyst-15 is used, but any suitable acid resin with comparable properties is acceptable. For example, a suitable ion exchange resin can have active sites less than or equal to 5.3 eq/kg, surface area of from about 30 to about 70 m2/gram, and be in the form of particles of any suitable size consistent with ease of handling and pressure drop across the reactor bed, for example, particle sizes greater than 0.5 mm.

Prior to use, an optional step was carried out to remove any color and free acid, the Amberlyst-15 resin was rinsed with an acetone/deionized water mixture multiple times, for example, 4 times, followed by further rinses with deionized water multiple times, for example, 6 times, until the rinse water was nearly neutral, for example, the pH was in the range of 5 to 7. The Amberlyst-15 resin was then dried in a full vacuum oven at 95° C. overnight to remove residue moisture before packing the resin into a fixed bed glass column for the experiments. The presence of methanolysis catalyst in mixtures was determined by acid-base titration carried out using a Metrohm Autotitrator with a method similar to ASTM D4662-93. The acid-base titration is expressed as alkalinity number (A.N. #) which is in milliequivalent of OH⁻ per 30 kg of sample. A positive A.N. # indicates an basic solution, i.e. the presence of base, and a negative A.N. # indicates an acidic solution, i.e. the presence of acid. Our calibration had shown that +1.0 A.N. # is equivalent to 1.9 ppm NaOCH₃ in a PTMEG/methanol solution, and 0.8 ppm Na⁺ ions.

### Example 1

In a jacketed glass column of 0.5 inch diameter and 3 feet length was packed 30.1 grams of the oven dried Amberlyst-15 resin. A 1 liter jacketed glass reactor equipped with a mechanical stirrer was loaded with 741.4 grams of PTMEG with a molecular weight of 2000 dalton, 223.5 grams anhydrous methanol and 36.0 grams of anhydrous 25 wt. % NaOCH₃/methanol solution, which upon mixing made a 74.1 wt. % PTMEG, 25.0 wt. % methanol and 9000 ppm NaOCH₃ mixture. This mixture is too concentrated to most accurately measure the NaOCH₃ content by the extremely sensitive A.N. # titration method. But the measurement did read the feed at about a +5184 A.N. # indicating a very strongly alkaline solution. The mixture inside the jacketed glass reactor was maintained at 50° C. while the glass column containing the resin was kept at 60° C. and 760 mmHg. The mixture was pumped through the resin bed with an upward flow at 2 liters feed/liters of resin-hour rate until the mixture was emptied from the stirred reactor. Under steady state conditions, the inlet pressure was about 1 bar. Liquid samples were collected at 60 minute internals and analyzed by titration for alkalinity. The first sample showed a relatively negative A.N. # of −34.2 meq OH⁻/30 kg, which suggests a total removal of the NaOCH₃ in the feed. However, it is believed that residue acid was released from the resin framework due to overnight drying of the resin in the oven (a known phenomenon with the Amberlyst-15 type of sulfonic acid resin). The second sample only had an A.N. # of −2.7 meq OH⁻/30 kg, and the A.N. # of the third sample was −0.08 meq OH⁻/30 kg. All of the results suggest the NaOCH₃ removal from the 9000 ppm NaOCH₃ anhydrous methanol/PTMEG mixture was close to 100% (<1.0 ppm metal ions) without adding additional water to the feed even in the presence of an extremely high concentration of the alkaline metal alkoxide catalyst.

### Example 2

In the same glass column as in Example 1 was loaded 30.0 grams of the oven dried Amberlyst-15 resin. However, the resin was rinsed by 361.5 grams anhydrous methanol at 52° C. by pumping the methanol up flow to remove the free acid that could be released from the resin upon drying. The remainder of the experiment was the same as Example 1. The A.N. # of the first sample (after 60 minutes) was −0.66 meq OH⁻/30 kg, the second A.N. # was −0.35 meq OH⁻/30 kg and the third sample's A.N. # was −0.27 meq OH⁻/30 kg. The data indicated the effective removal of free acid from the dried resin by anhydrous methanol rinse and also the efficient removal of the very highly concentrated NaOCH₃ from the PTMEG/methanol/catalyst mixture to much less than 1.0 ppm metal ions without adding water to the mixture.

While the illustrative embodiments of the invention have been described with particularity, it will be understood that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present invention, including all features which would be treated as equivalents thereof by those skilled in the art to which the invention pertains.

1. A process for converting the diester of a polyether polyol to a corresponding dihydroxy polyether polyol comprising steps of: (1) contacting the diester of a polyether polyol and a Ci to C4 alkanol with alkali or alkaline earth metal catalyst in a reaction zone to convert at least a portion of the diester, for example >99 wt. %, for example >99.99 wt. %, to the dihydroxy polyether polyol, (2) recovering reaction zone effluent from the reaction zone of step (1) comprising dihydroxy polyether polyol, alkanol and catalyst, essentially free of the alkanol acetate by-product, e.g., methyl acetate, (3) contacting the recovered reaction zone effluent of step (2), in the absence of added water, with ion exchange resin having active sites less than or equal to 5.3 eq/kg, surface area of from about 30 to about 70 m2/gram in the form of particles of size consistent with ease of handling and acceptable pressure drop across the reaction zone, said contacting being performed at conditions including temperature of from 40 to 80° C., and pressure from 760 to 900 mmHg, and (4) recovering effluent from contacting step (3) comprising less than 1.0 ppm alkali or alkaline earth metal ions.

2. The process of claim 1, wherein the recovered reaction zone effluent of step (2) is contacted with the ion exchange resin such that the recovered reaction zone effluent has a flow rate from ½ to 5 liters feed/liters of resin-hour.

3. The process of claim 1 wherein the alkanol is methanol, the catalyst is sodium methylate and at least 80% by weight of the diester of polyether polyol is converted to the corresponding dihydroxy polyether polyol.

4. The process of claim 3 wherein the diester of polyether polyol is the diacetate ester of polytetramethylene ether.

5. A method for removing alkali or alkaline earth metal alkoxide catalyst from a mixture comprising polytetraalkylene ether glycol, alkanol and alkali or alkaline earth metal catalyst, which comprises steps of: (1) contacting the mixture with ion exchange resin having active sites less than or equal to 5.3 eq/kg, surface area of from about 30 to about 70 m2/gram in the form of particles of size consistent with ease of handling and acceptable pressure drop across the reaction zone, at contact conditions including a temperature of from 40 to 80° C., and pressure from 760 to 900 mmHg, and (2) recovering effluent mixture from step (1) comprising less than 1.0 ppm alkali or alkaline earth metal ions.

6. The method of claim 5 wherein the mixture is contact with the ion exchange resin such that the mixture has a flow rate from ½ to 5 liters feed/liters of resin-hour.

7. The method of claim 5 wherein the resin has a particle size in excess of 0.5 mm to minimize the pressure drop introduced by the flow of viscous polymer solution.

8. The method of claim 5 wherein the temperature is less than 80° C. to minimize the depolymerization of the polymer to the monomer.

9. The method of claim 5 wherein the alkanol comprises methanol and the polytetraalkylene ether glycol comprises polytetramethylene ether glycol.

10. The method of claim 6 wherein the alkali or alkaline earth metal catalyst comprises alkali metal alkoxide.

11. The method of claim 8 wherein the catalyst comprises sodium methylate.

12. An apparatus for converting the diester of a poly ether polyol to a corresponding dihydroxy polyether polyol, comprising: (1) a reactor for contacting the diester of a polyether polyol and a to C₄ alkanol with alkali or alkaline earth metal catalyst to convert at least a portion of the diester, for example >99 wt. %, for example >99.99 wt. %, to the dihydroxy polyether polyol to produce a reactor effluent; and (2) an ion exchange resin column packed with ion exchange resin having active sites less than or equal to 5.3 eq/kg, surface area of from about 30 to about 70 m2/gram in the form of particles of size consistent with ease of handling and acceptable pressure drop across the ion exchange resin column, being operatively connected to the reactor, for contacting the reactor effluent, in the absence of added water, with the ion exchange resin, said contacting being performed at conditions including temperature of from 40 to 80° C., and pressure from 760 to 900 mmHg.

13. The apparatus of claim 12, further comprising a pump between the reactor and the exchange resin column for feeding the reactor effluent into the exchange resin column such that the reactor effluent in the exchange resin column has a flow rate from ½ to 5 liters feed liters of resin-hour.

14. The apparatus of claim 12, wherein the reactor is selected from the group consisting of a continuous stirred tank reactor, a batch reactor, or a tubular concurrent reactor.

15. The apparatus of claim 12, wherein the reactor is a single distillation column.

16. The apparatus of claim 12, wherein the reactor is a deep seal sieve tray distillation column.

17. The apparatus of claim 12, wherein the ion exchange resin column is a jacketed metal column.

18. The apparatus of claim 12, wherein the reactor is a jacketed metal column equipped with a mechanical stirrer.

19. The apparatus of claim 12, further comprising a pump between the reactor and the exchange resin column for feeding the reactor effluent into the exchange resin column from the bottom of the exchange resin column such that the reactor effluent in the exchange resin column has an upward flow rate from ½ to 5 liters feed/liters of resin-hour.

20. The apparatus of claim 17 or 18 wherein the metal column is glass-lined.
